(19) United States
(12) Patent Application Publication
(10) Pub. No.: US 2008/0140464 A1
(43) Pub. Date: Jun. 12, 2008

(54) Travel planning system that produces answers involving mulitple sales channels/PNRs/tickets per answer

(76) Inventor: Carl G. de Marcken, Seattle, WA (US)

Correspondence Address: FISH & RICHARDSON PC, P.O. BOX 1022, MINNEAPOLIS, MN, 55440-1022, US

(21) Appl. No.: 11/635,400

(22) Filed: Dec. 7, 2006

(51) Int. Cl. G01C 21/34

(52) U.S. Cl. 705/6

(57) ABSTRACT

Techniques for producing a travel solution comprised of multiple travel units are disclosed. The techniques include sending a travel planning query having a partition specification to a travel planning system. The travel planning system processes the travel query to produce solutions based on partitions. Possible partitions can include passenger name records (PNRs), tickets or sales channels for the returned solutions. Processing can involve relaxing constraints, rules or regulations on solutions and re-pricing solutions, as multiple tickets, by partitioning the solutions by a partition. Tickets can be produced for different portions of the multiple travel units from the travel solution using different selling methods or points of sale channels.

This invention relates to travel pricing, and more particularly, to pricing for air travel.

Travelers and travel agents pose air travel planning queries to computer travel planning systems (travel planning system), such as travel web sites, airline-specific web sites, or interfaces supplied by global distribution systems (GDSs) as used by travel agents. One type of query typically supported by travel planning systems is the so-called low-fare-search (LFS) query. In response to an LFS query travel planning systems return a list of possible answers including flight and price information. The answers may also take other forms such as a pricing graph.

A traveler or travel agent selects for purchase one of the answers returned by the travel planning system. The travel agent, or a computer booking system, electronically interacts with a global distribution system (GDS) or an airline reservation system (ARS) to reserve seats on the appropriate flights and provide payment.

In the airline industry this interaction typically involves the construction of a passenger name record (PNR), the industry standard database representation for a passenger's trip that includes flight, booking-code, fare and payment information, as well as passenger names and contact information. PNRs are typically assigned alphanumeric record locators.

Another unit of representation in the airline industry is a ticket. Typically, each passenger has a separate ticket, whereas multiple tickets may be referenced by one PNR. Tickets typically receive their own industry-wide identifier, called a ticket number.

The ticket and the PNR are fundamental units of representations of interaction in the airline industry. Generally, airlines, governmental authorities, GDS's and travel agents use these units as the basis for accounting, billing, regulatory or contractual requirements, and electronic data interchange protocols. This imposes limitations on the forms that valid tickets and PNRs can have.

### SUMMARY

According to an aspect of the present invention, a method for producing a travel solution comprised of multiple travel units, includes sending a travel planning query to a travel planning system, the travel query including a specification of whether or not to expand a search space to include multiple passenger name records, or tickets or sales channels and processing the travel query to return solutions with a specification of possible partitions of the solutions into at least one of passenger name records (PNRs), tickets or sales channels for the returned solutions.

The following are embodiments within the scope of the claims.

The query specifies the types of partitions that are allowed. The type of partition of complete solutions is to sell multiple passengers individually. The type of partition of complete solutions is to sell each priceable unit separately. The type of partition of complete solutions is to sell each airline separately. The type of partition of complete solutions is to sell each slice or trip-segment separately. Processing includes processing the query by generating a plurality of possible itineraries comprised of flight sequences for the entire journey and, thereafter, pricing each itinerary to produce a set of solutions. Generating a plurality of possible itineraries includes enumerating sets of sub-itineraries for each slice, producing a cross product of the enumerated sets of sub-itineraries to provide resulting possible itineraries and pruning the resulting possible itineraries to a manageable number of whole-trip itineraries based upon criteria. Pricing includes pricing each sub-itinerary, for each slice, as a single ticket. Pricing includes pricing multiple-ticket options by combining per-trip-segment tickets. Pricing includes determining a set of cheapest multiple-ticket solutions by constructing the set from the cheapest tickets for each trip segment and adding the cheapest multi-ticket solutions to the set of solutions.

According to an additional aspect of the present invention, a computer program product residing on a computer readable medium for producing a travel solution comprised of multiple travel units includes instructions to send a travel planning query to a travel planning system, the travel query including a specification of whether or not to expand a search space to include multiple passenger name records, or tickets or sales channels and process the travel query to return solutions with a specification of possible partitions of the solutions into at least one of passenger name records (PNRs), tickets or sales channels for the returned solutions.

One or more aspects of the invention may provide one or more of the following advantages.

With these techniques a travel planning system need not restrict answers (travel options) to those that can be sold as a single ticket or passenger name record (PNR), or through a single sales channel. Removal of such a restriction may return better answers for a passenger or passengers willing to travel on multiple tickets or PNRs. This can result in price savings. For instance, different fare codes can be used for different parts of a journey which can result in substantial savings on fares, e.g., as Y fares are typically much more expensive than Q fares. As a second example, dividing flights across tickets may enable a convenient or inexpensive airline combination that would otherwise be unavailable. As there are many interacting considerations in determining whether it is possible or desirable to sell a trip as several as opposed to one ticket, it is desirable that such consideration take place within the travel planning system. These techniques allow the travel planning search space to include not just flights and fares, but also the manner in which the flights and fares are sold, including the possibility of splitting passengers and flights across multiple tickets or PNRs or sales channels.

These techniques include various approaches for enhancing different types of travel planning systems and itinerary pricing systems to search over the possibility of booking a trip using more than one PNR or ticket or sales channel.

Aspects of the invention permit multiple PNRs to cover an entire solution, either because different passengers are placed in different PNRs or different flights are placed in different PNRs, or both and/or techniques where multiple tickets are used to cover a single PNR (e.g., where a passenger's payment for multiple flights in a single PNR are recorded in multiple tickets rather than a single ticket.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram including a travel planning system.

FIG. 2 is a flow chart of a multiple ticket search in a travel planning system using sequential pricing of itineraries.

FIG. 3 is a flow chart that shows a process to artificially inflate availability information.

FIG. 4A is a flow chart of a technique for using a sequential pricing travel planning system that re-prices a subset of solutions.

FIG. 4B is a flow chart depicting a technique for checking constraints.

FIGS. 5A-5B are flow charts of a technique for pricing by relaxing constraints, rules, or regulations on solutions.

FIGS. 6A-6B are flow charts of a technique for pricing by allowing multiple passengers to be booked using different booking codes.

FIGS. 7A-7D, are flow charts of a faring process that shares computational efforts across per slice and whole journey pricings.

FIGS. 8 and 9 are flow charts of a technique to process a set of possible points of sale and to provide a choice of which points of sale to select.

### DETAILED DESCRIPTION

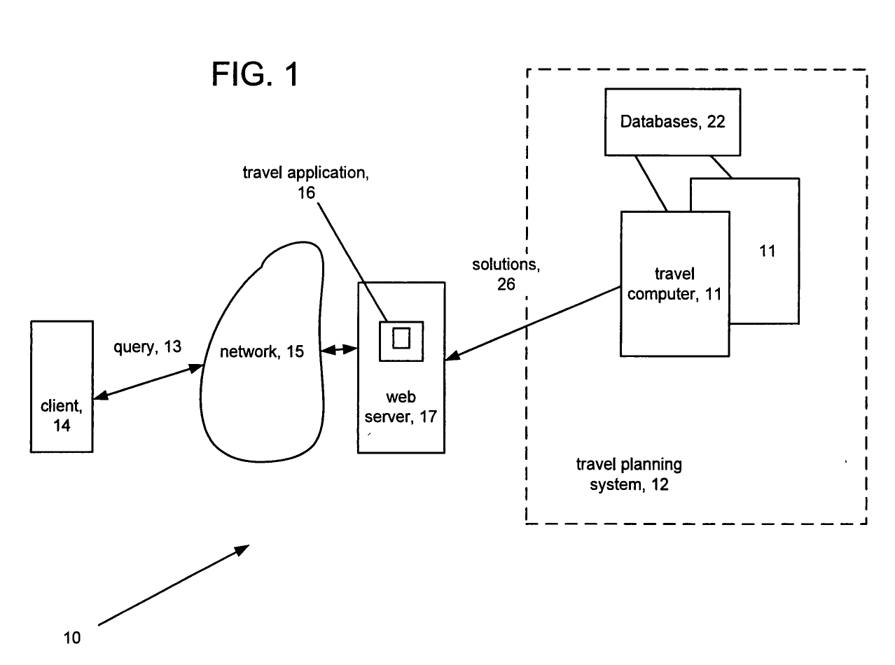

Referring to FIG. 1, an arrangement 10 includes one or more server type computer systems 12 that implements a travel planning system (travel planning system) 11 that searches for airline tickets in response to queries 13 using so-called large scale or low-fare-search algorithms. The travel planning system 12 is typically a server type of computer system, or a cluster or farm of such server types of computers. Typically the computer includes memory, a processor, interfaces, networking support and storage, e.g., computer readable media storing various computer programs, data structures and so forth to implement features of the travel planning system. The travel planning system 12 finds valid flight sequences between pairs of specified end-points in response to a query 13 received from a client system 14. In one embodiment, the client 14 communicates with the travel planning system (travel planning system) 12, via a network such as the Internet 15 through a web server 17.

The client 14 sends the query 13 to, the web server 17 or directly to the travel planning system (travel planning system) 12. The process of finding flight sequences for a portion of a trip is commonly called “scheduling.” Scheduling uses flight information contained in travel information databases 22. A particular flight sequence for a portion of a trip is an “itinerary.” Typically, the travel planning system attempts 10 to find prices for one or more combinations of itineraries from each portion of a trip.

Various types of travel planning systems 11 are known. One type of travel planning system generates a plurality of possible itineraries (flight sequences) for the entire journey and then prices each itinerary separately. Another type of travel planning system processes travel queries more efficiently by sharing computational efforts in pricing per-slice and whole journey pricings.

One such travel planning system 11 that shares computational efforts is described in U.S. Pat. No. 6,381,578, by Carl G. deMarcken entitled: “Factored Representation Of A Set Of Priceable Units” filed as application Ser. No. 09/109,876 on Jul. 2, 1998 and assigned to the assignee of this application, ITA Software, Inc. (Cambridge, Mass.). The techniques disclosed in that patent price many itineraries simultaneously.

The process of finding prices for a specific combination of itineraries (equivalently, sequence of flights on a ticket) is known as “pricing” a set of flights, or “pricing a ticket” also referred to as a “faring process.” The process of pricing the flights of a ticket involves retrieving fares from a fare database 22 and choosing fares for particular sub-sequences of flights such that all flights are paid for by exactly one fare. Pricing the flights can include grouping fares into priceable-units, and verifying that fare rules permit the particular choices of fares and priceable-units.

A fare is a price an airline offers for one-way travel between two airports that has associated restrictions on its usage called “rules.” If a fare's rules permit, a fare may cover more than one flight, and tickets may be priced using more than one fare. In international travel, airlines publish fares in markets that often require many flights to get between a desired origin and destination.

The travel planning system 11 responds to LFS queries 13 that typically include origins and destinations, and travel times for each segment of a trip.

As used herein the complete set of passengers, flights and fares that satisfies a travel planning query will be called a “complete solution.” A complete solution 26 as described below can be reserved, booked, or sold as one (Passenger Name Record) PNR and/or ticket, or alternatively, as several PNRs and/or tickets. An individual ticket or PNR is a subset of a complete solution that can be purchased independently, and includes all or a proper subset of passengers, all or a proper subset or flights, and all or a proper subset of fares.

In the airline industry a PNR (passenger name record) is a record containing a set of flights, a set of passenger names, and passenger contact information. A ticket, on the other hand, is a record of payment and that contains information about the fares used to pay for flights as well as proof of payment. In general, each passenger on a PNR is issued a separate ticket that provides payment information for all the flights on the PNR.

Described below are techniques to permit multiple PNRs to cover an entire solution, either because different passengers are placed in different PNRs or different flights are placed in different PNRs, or both) and/or techniques where multiple tickets are used to cover a single PNR (e.g., where a passenger's payment for multiple flights in a single PNR are recorded in multiple tickets rather than a single ticket.

For a complete solution 26 of substantial size there are many ways to partition the solution into PNRs and/or tickets, although only some will result in a valid, book-able combination. Some ways of partitioning complete solutions are more likely than others to result in valid tickets and/or PNRs, and some are more likely than others to bypass booking or pricing restrictions that would apply if a single ticket and/or PNR and/or sales channel were used.

One technique to partition complete solutions is to sell multiple passengers individually. Putting each passenger on their own PNR overcomes the industry restriction that every person on a PNR must use the same booking code for a flight, preventing a cheaper mixed booking code solution in the situation where flight availability is for instance Y2, Q1. It may be computationally expedient in a travel planning system to avoid placing children or infants on their own PNR, as typically restrictions may prevent them from being priced without an accompanying adult.

Another technique to partition complete solutions is to sell each priceable unit separately. A priceable unit is an industry term that represents a fundamental unit at which many fare restrictions apply. For example, round trip fares often include minimum stay requirements and these can only be expressed when both an outbound and a return fare are combined. With this technique each priceable unit (PU) of a complete solution is sold on the same ticket, however, it is not uncommon for end-on-end restrictions or airline joint ticketing agreements to prevent multiple PUs from appearing on the same ticket. Selling each separately is one way to work around these restrictions. One difficulty of this method is that the partition is not determined until the fares and priceable units have been fixed, making it difficult to implement in some travel planning systems.

A further technique to partition complete solutions is to sell the flights or fares of each airline separately. Many of the same benefits that are achieved by selling PUs separately are also achieved by selling the flights of each airline separately, since end-on-end and joint ticketing agreements often only prevent airline combinations from appearing on the same ticket.

Still another technique to partition complete solutions is to sell each slice (trip-segment) separately. Typically, LFS queries and solutions are conceptually divided into trip-segments, or slices, that represent the sub-portion between extended layovers. For example, “round trip” queries are divided into two slices, and the solutions are likewise divided into two slices. There are a number of reasons why it may be impractical to place the flights of a single slice on multiple PNRs and/or tickets, including baggage transfer arrangements and airlines' reluctance to take responsibility for flight delays. For this reason, dividing a solution into PNRs and/or tickets by slices, or subsets of slices, may be desirable. For example, a ticket with three slices could be divided into 3 tickets, or any one of 3 combinations of a two-slice ticket with a one slice ticket. A further advantage of such partitions is that there is a smaller search space than with PUs, and the possibilities are fixed given the flights. Not all of these possibilities are exclusive. For example, a complete solution could be split both by passenger and by priceable unit, airline, or slice.

Travel agents and travelers are capable of manually splitting a solution into multiple parts and booking them separately. However, travel agents and travelers would have to manually split a solution on their own initiative, rather than using an automated process to inform them of when it is beneficial and when it is not beneficial to split a solution. Because of these limitations, it is unusual for a travel agent and especially a traveler to split solutions.

As will be discussed below, travel planning systems and itinerary pricing systems can be constructed to accept queries that include a specification of whether or not to expand a search space to include the possibility of multiple PNRs and/or tickets and/or sales channels, and to return with the solutions a specification of the partition into PNRs and/or tickets (or other instructions for modifications to the ordinary booking and ticketing process) for the returned solutions. The query would specify the kinds of partitions that are allowed. For example, the query would include a specification restricting the partitions to slice-based flight partitions or requiring that certain sets of passengers be placed in a common PNR.

### Multi-Ticket Searches with Sequential Pricing Systems

Some travel planning systems perform LFS queries by first generating a multitude of possible complete itineraries (flight sequences) for all slices for the entire journey and then price each itinerary sequentially, e.g., pricing a first itinerary, then pricing a second, and so forth. While inefficient, this technique is a relatively straightforward technique to process LFS queries, given a pre-existing itinerary pricing system.

Here the phrase “Complete Itinerary” refers to all the flights in a solution rather than the flights of a single slice (trip-segment) of the solution (I), whereas, the word “Itinerary” corresponds to the flight sequences in a single slice (trip segment) of a journey.

In such a system, a multiple ticket or multiple-PNR search can be implemented as an outer search layer. In particular, if a multiple slice query is posed, the travel planning system determines complete itineraries for the entire journey and prices each slice of the journey, as usual. This is typically accomplished in such systems, by enumerating sets of itineraries for each slice and taking a cross product of the sets of itineraries for each slice, pruning the result of the cross product to a manageable number of complete itineraries, and price each complete itinerary individually.

To provide a multiple ticket/PNR search, each sub-itinerary (for each slice) is priced as a single unit. The multiple-unit options are constructed by combining per-trip-segment pricings. For example, the cheapest multiple-ticket solution is constructed from the cheapest tickets for each trip segment. Such a solution can be added to the set of solutions constructed by a conventional search method.

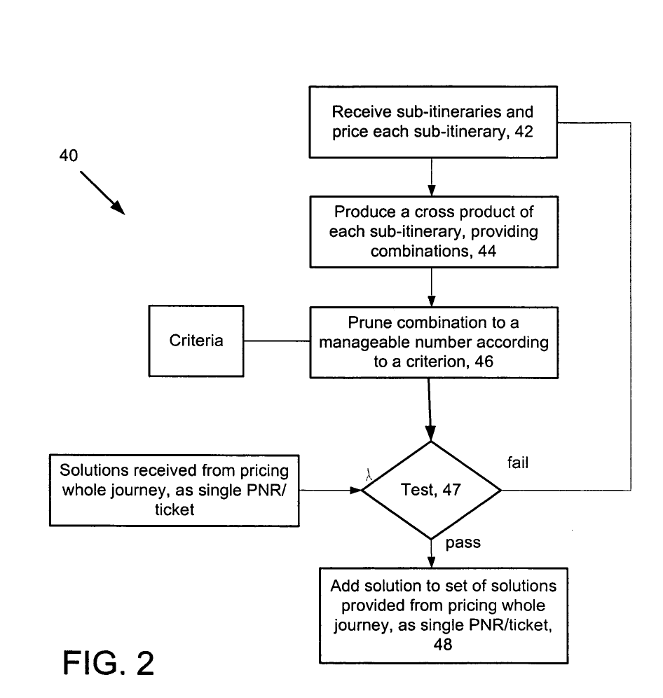

Referring to FIG. 2, a technique 40 for pricing each itinerary (for each slice) as a single PNR and/or ticket (unit) in a travel planning system that generates a plurality of possible itineraries (flight sequences) for the entire journey or a complete itinerary and that prices each complete itinerary is shown. The multiple-unit options are constructed by combining per-trip-segment units. For example, the cheapest multiple-ticket solution is constructed from the cheapest tickets for each trip segment. The technique prices 42 each itinerary, and produces 44 a cross-product of each itinerary ticket to produce whole-journey, e.g., complete itinerary, multi-ticket solutions. The technique prunes or deletes 46 the resulting possible combinations to a manageable number of whole-trip combinations, based upon some specified criteria. Criteria can include the price or convenience of the combination. The technique tests 47 the resulting solutions produced by the cross-product and if the resulting solutions are better than (e.g., more expensive) solutions produced from pricing the whole journey, as single PNRs and/or tickets for the whole journey, the technique 40 adds 48 the resulting solutions to set of normally produced solutions.

One disadvantage of such a technique is that computational effort is not shared between per-slice pricings and whole-journey pricings. This can result in prohibitive computational cost. Other examples of explicit consideration of different split techniques can be used in travel planning systems that work by pricing itineraries.

For example, given a complete itinerary, the flights in the complete itinerary can be partitioned by carrier and each flight set priced separately. The total effort involved is unlikely to be greater than twice the cost of the whole-itinerary pricing. Similarly, each passenger in a multi-passenger query can be priced separately with seat availability artificially decreased for latter passengers to account for earlier use of seats for the earlier-priced passengers. Thus, if seat availability is such that a cheap booking code is available for only one passenger, and the travel planning system would ordinarily price all passengers using the same booking code, the alternative possibility that multiple PNRs are used is considered. To be more explicit an initial pricing is performed for one passenger with full seat availability. Suppose that the passenger is priced using booking code X for a flight segment, and the original seat availability for that booking code is X_{N}. Then seat availability for X is decreased artificially to X_{N}−1, every other booking code Y in the same cabin is likewise decreased to Y_{N}−1 (because the sale of one may impact the availability of the rest), and the artificial availability used for a second pricing for the second passenger. Such a process can be iterated over any number of passengers. Again, the total effort is not a substantial multiple over the expense of the all-passenger pricing.

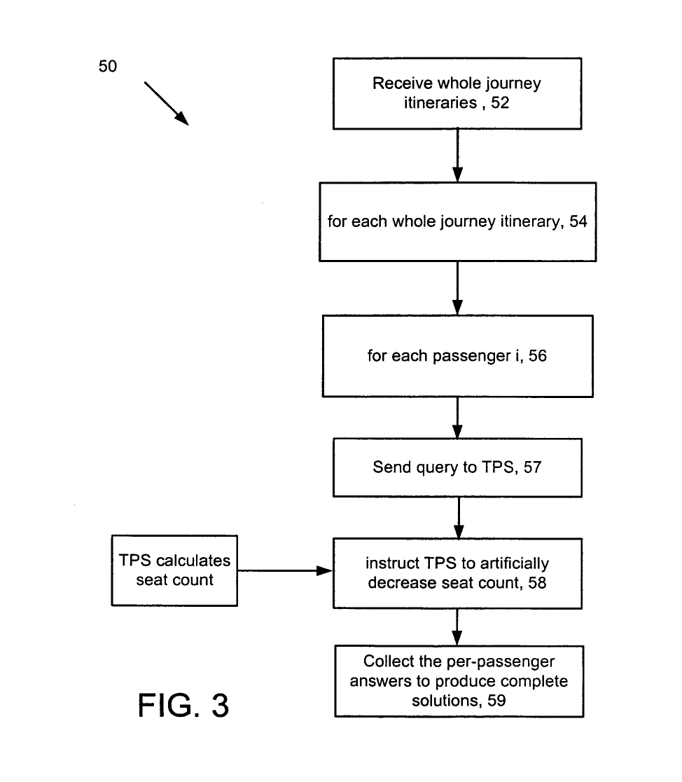

Referring to FIG. 3, a technique 50 for pricing multi-passengers is shown. In the technique 50, the process receives whole journey itineraries 52 and for each (whole-journey) complete itinerary 54 and for each passenger i, 56, the process 50 sends 57 a query to a travel planning system for the passenger i, and provides 58 in the query an indication that the TPS should internally decrease whatever seat counts the TPS arrives at during its ordinary process of retrieving available seat counts for flights by a specified sum, computed by the querier as the sum of passengers from 1 . . . i−1. The technique 50 collects 59 the per-passenger answers to form a complete solution.

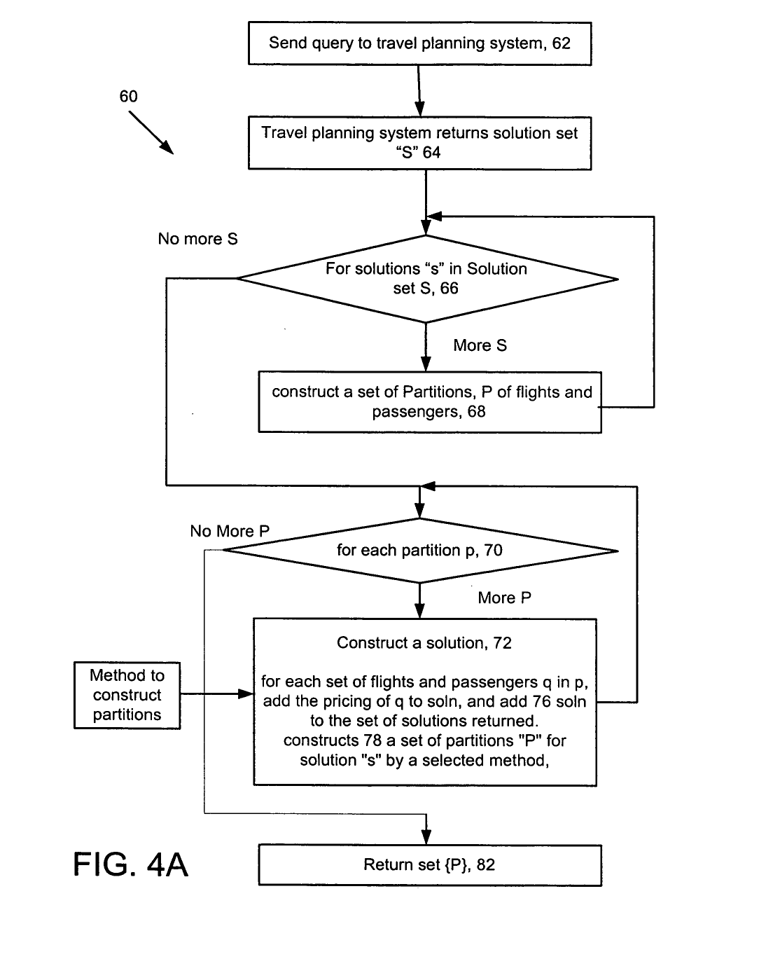

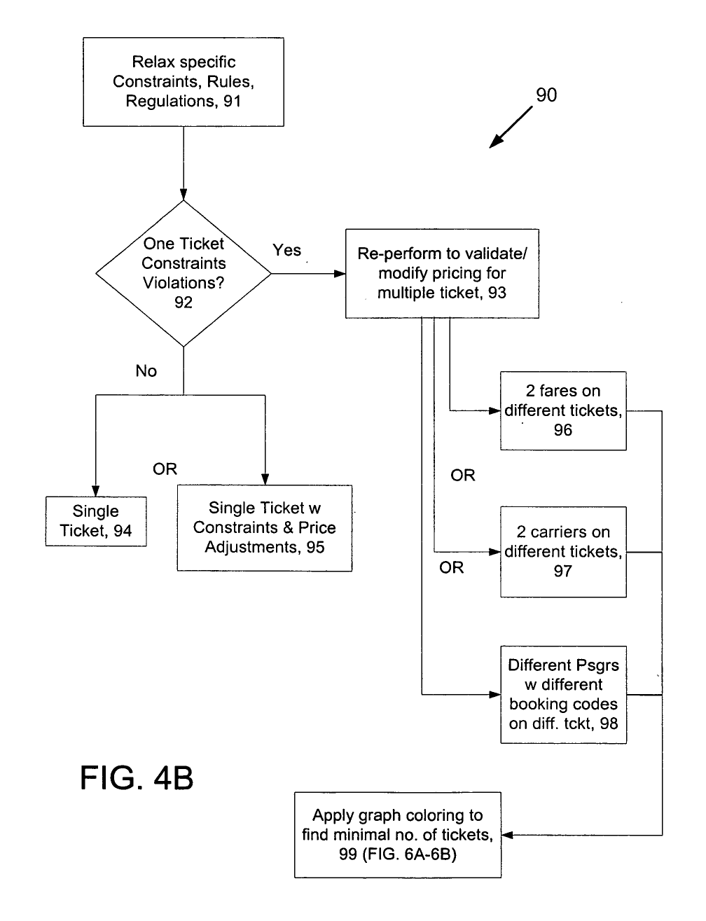

Referring to FIG. 4, process 60 depicts an alternative implementation of splitting. A travel planning system finds complete itineraries (flight sequences) for the entire journey and thereafter prices each complete itinerary separately. Process 60 takes a subset of the solutions produced and re-prices the subset of solutions, as multiple PNRs and/or tickets. For example, process 60 partitions the solutions by trip segment or carrier or passenger, and thereafter re-prices each partition. If the total price or other properties of interest are improved by the combination of the multiple tickets, then that pricing method is returned in addition or in place of the whole-journey pricing. One advantage of this process 60 is that the extra computational effort of exploring multiple PNRs and/or tickets is expended only on solutions that have been vetted by ordinary pricing mechanisms.

Process 60 for using a sequential pricing travel planning system that re-prices a subset of solutions returned, as multiple tickets includes sending 62 a user query for travel to a travel planning system. The travel planning system returns 64 a solution set S. For some or all solutions s in solution set S, 66, the technique 60 constructs 68 a set P of partitions of flights and passengers of s (each partition p in P is a different way of dividing s into multiple pieces).

For each partition 70 p in P, a solution “soln” is constructed 72. That is, the technique 60, lets 70 “soln”={ }, and for each set of flights and passengers q in p 72, the process 60 adds the pricing of q to soln, and adds 74 soln to the set of solutions returned. The technique 60 constructs a set of partitions “P” for solution “s” by some method. Let p={ }. Several methods are set forth below that construct different partitions p of s and add p to the set of partitions P:

```
(method 1: by slice)
p = { };
    for each slice i
      p = p + { flight f in s : slice(f) = i }
P = P + p
(method 2: by airline)
p = { }
    for each airline a appearing in s
      p = p + { flight f in s : airline(f) = a }
P = P + p
(method 3: by priceable unit)
p = { }
    for each priceable unit w appearing in pricing of s
      p = p + { flight f in s : priceable-unit(f) = w }
P = P + p
```

The process 60 returns 82 the set P. One or more partitions may be selected and the technique need not use all of the partition methods or determine all of the partitions, as described above.

Another implementation performs LFS or itinerary pricing by relaxing constraints, rules, or regulations on solutions that would be circumvented if multiple PNRs and/or tickets were used to sell solutions.

Referring now to FIG. 4B, process 90 performs itinerary pricing by relaxing constraints, rules and/or regulations. For example, end-on-end restrictions, carrier-combination restrictions and same booking-code restrictions are relaxed. One or more constraints, rules and/or regulations are relaxed, meaning that the logic to evaluate fares according to fare rules is altered so as to apply the specified “relaxed” constraints, rules and/or regulations 91.

For example, if the TPS ordinarily applies a rule check that enforced end-on-end fare restrictions, that rule check is turned off for this search. In other respects, the search can be unaltered. While there is no guarantee that the resulting pricings are valid, even if sold as multiple tickets, the solutions can be checked in a post-processing pass to determine whether the solutions violate any constraints if sold as a single unit 92. That is, any rule checks that were skipped in the initial processing are applied to the entirety of the solution to check whether the complete solution could, in fact, be sold as a single unit.

If a complete solution contains a constraint violation after the check 92, the pricing of the complete solution is performed again, 93, but this time on individual portions of the complete solution to validate the multiple-ticket possibility. The details of this process are described further below. If the complete solution does not contain any constraint violations, the complete solution is sold as a single unit 94, or re-priced as a single unit with the constraints enforced rather than relaxed 95, for additional assurance of its validity.

The advantage of this implementation is that the search over methods for splitting the journey is guided by the lowest-priced complete solution. If the complete solution does not contain constraint violations, there is no need to consider the possibility of selling as multiple units.

However, if the complete solution does contain constraint violations, methods for splitting include placing two fares that are incompatible on different tickets 96, placing two carriers that are incompatible on different PNRs/tickets 97, or placing multiple passengers that use different booking codes on different PNRs 98.

One method for finding the division into the minimal number of selling units necessary is to treat the problem as one of graph coloring. Graph coloring is a computer science problem of assigning “colors” (e.g., numbers 1, 2, . . . ) to the vertices of a graph such that no two vertices connected by an edge have the same color (e.g., number). Graph coloring can be envisioned as the problem of assigning colors to a wall map of the United States such that no two adjacent states are colored the same. In processing, a graph coloring algorithm is applied 99 to the solutions to find a minimal number of selling units, the graph vertices representing solution pieces such as flights and fares. If constraints prevent two solution pieces from appearing on the same ticket or PNR, the solution pieces are connected by an edge. One of many standard algorithms is run to search for an assignment of colors to graph vertices; these algorithms attempt to find the smallest set of colors sufficient for coloring all the vertices. At the end, fares and flights assigned the same color are part of the same ticket/PNR. Entities on a solution such as flights and fares are represented as vertices in a graph. Edges exist between vertices if the two vertices are incompatible in a ticket or PNR. Vertices that need to appear together on a ticket, such as multiple fares in the same PU, are collapsed (replaced with a single vertex that has all edges going to it that go to any of the original vertices). Then, a minimal graph coloring algorithm is run, and entities that are assigned the same color are placed on the same PNR or ticket for re-pricing.

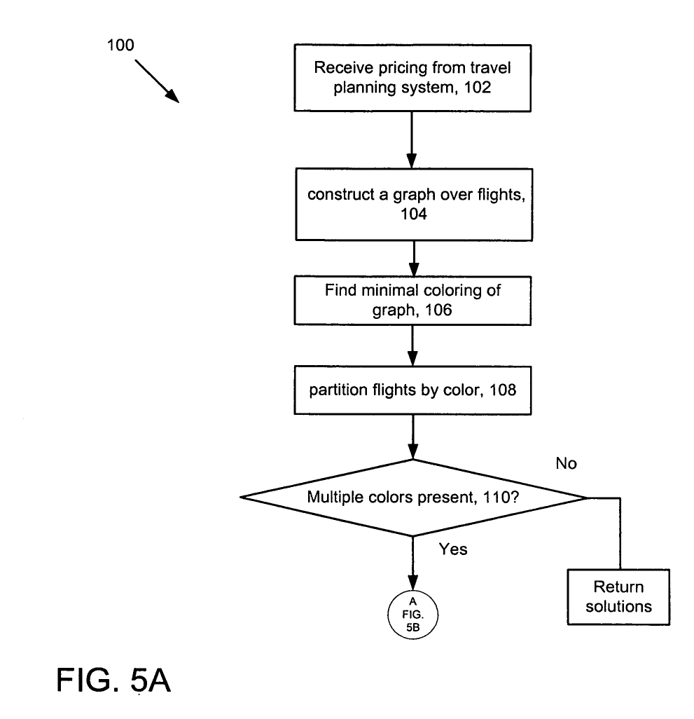

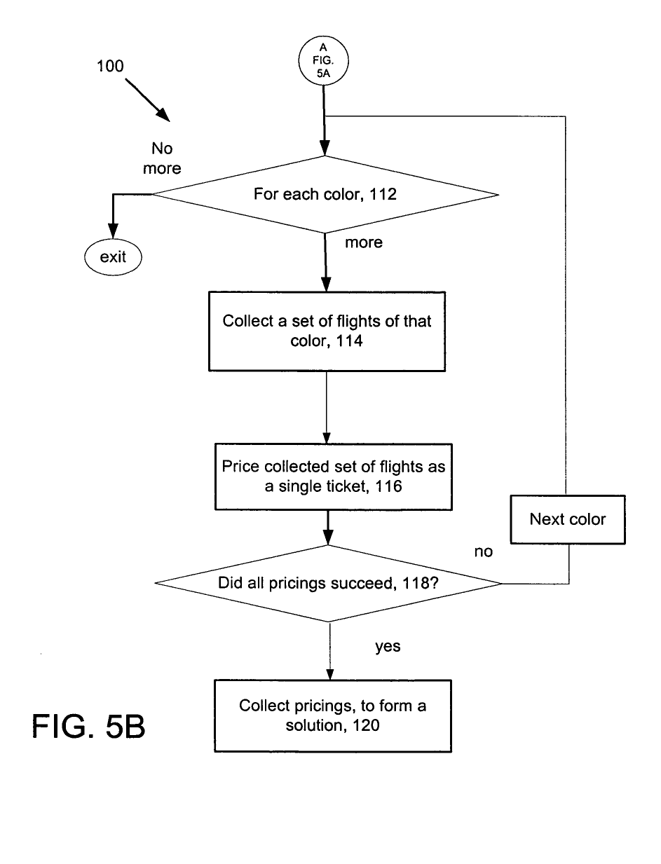

Referring to FIGS. 5A-5B, a process 100 for pricing by relaxing constraints, rules, or regulations on solutions, if priced or sold as multiple PNRs or tickets is shown. The process 100 prices flights and passengers by relaxing ordinary ticket/PNR constraints such as end-on-end fare combinability restrictions; and/or ticket carrier combination restrictions; and/or sales channel combination restrictions. These checks are applied to the resulting pricings to determine whether pairs of flights or fares are incompatible under the one-PNR/ticket assumption.

The process 100 receives 102 pricing “z,” and constructs 104 a graph over flights by connecting two flights if they violate carrier ticket combination restrictions; connecting two flights if they are covered by two different fares that violate each other's end-on-end combinability restrictions; or, require different sales channels

The process 100 runs 106 a graph coloring algorithm to find a minimal coloring of the graph, and partitions 108 the flights by color. The process 100 tests 110 to see if multiple colors are present. If not, the process 100 returns solutions. Otherwise, the process 100 for each color c, 112, collects 114 a set of flights of that color and prices 116 the collected set of flights as a single ticket. The process 100 tests 118 to see if all pricings succeeded and, if so, collects 122 pricings to form a solution. If pricings did not succeed, the process 100 processes the next color.

The process 100 can be extended to allow multiple passengers to be booked using different booking codes.

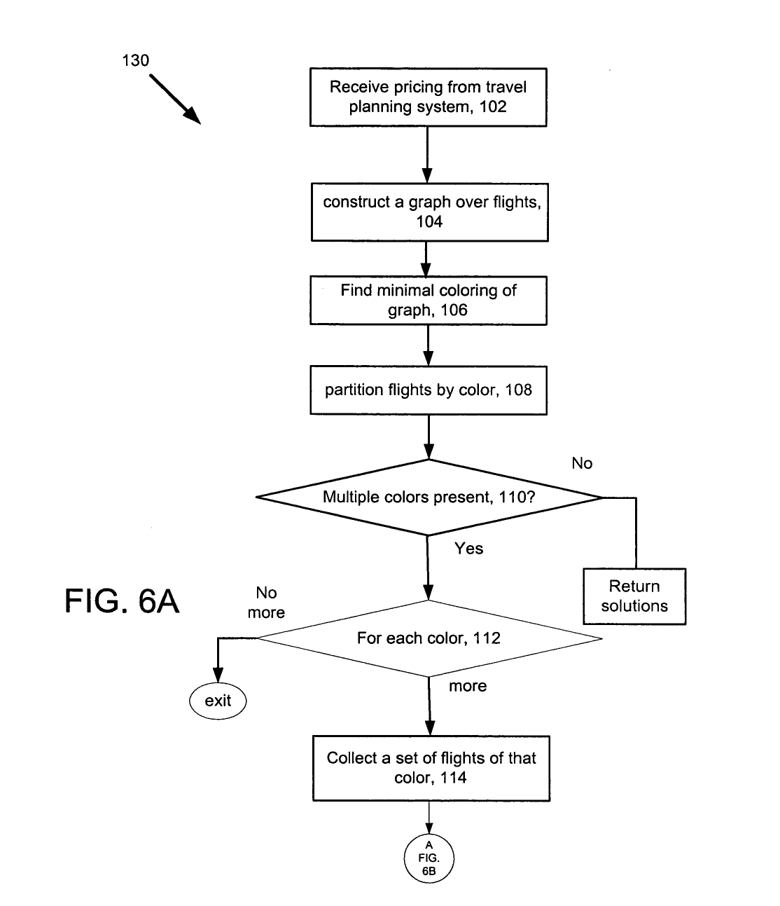

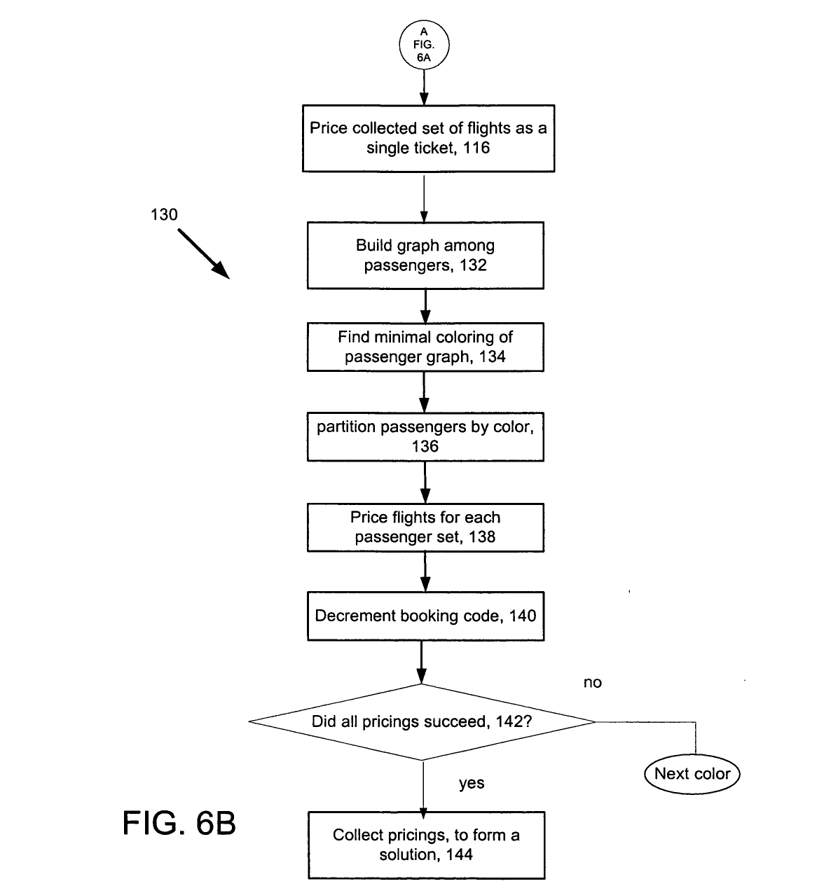

Referring to FIGS. 6A-6B, a process 130 for pricing by allowing multiple passengers to be booked using different booking codes is shown. The process 130 uses similar processes, as mentioned above in FIGS. 5A-5B and is illustrated in FIG. 6A using the same numbers as FIGS. 5A-5B for illustration. The technique 130 prices flights and passengers, relaxing ordinary ticket/PNR constraints such as end-on-end fare combinability restrictions; and/or ticket carrier combination restrictions; and/or sales channel combination restrictions and also relaxes all-passengers-must-use-same-booking-code restrictions.

The process 130 receives 102 pricing “z” and constructs 104 a graph over flights by connecting two flights if they violate carrier ticket combination restrictions, connecting two flights if they are covered by two different fares that violate each other's end-on-end combinability restrictions or require different sales channels.

The process 130 runs 106 a graph coloring algorithm to find minimal coloring of the graph and partitions 108 the flights by color. The process tests 110 to see if multiple colors are present, and for each color c, 112, the process 130 collects 114 a set of flights of that color and prices 116 the collected set of flights as a single ticket.

After the set of flights for a color has been collected, the process 130 builds 132 a graph among passengers by connecting two passengers if they use a different booking code for any flight. Then a minimal graph coloring 134 is performed over the passenger graph and partitions 136 passengers by color. The technique 130 prices 138 flights for each passenger set (passengers of a color) separately and performs 140 a booking-code decrement on subsequent passenger sets to account for the other passengers on the same flights. The technique tests 130 to see if all passenger pricings succeeded 142 and, if so, collects 144 pricings to form a solution. Thus the process 130 assigns each passenger a color and re-prices each color as a single unit. In order for the entire solution to be valid, each color would need to succeed.

Integrated Search Over Multiple Tickets

There are a number of drawbacks to the previously mentioned schemes for layering multiple-PNR/ticket searches using a travel planning system that does not share computational effort across per slice and whole journey pricings. One drawback is that the computational effort required increases for every splitting type considered, as well as for every itinerary priced. For a complicated journey, with many flights or passengers or potential points of sale, the amount of additional computational effort may be an exponential increase, making such splitting computationally prohibitive for a variety of split possibilities. It would be more efficient to perform splitting into multiple-PNR/tickets in an integrated fashion.

Some types of travel planning systems process travel queries more efficiently by sharing computational efforts in pricing per-slice and whole journey pricings. One such travel planning system is described in U.S. Pat. No. 6,381,578, by Carl G. de Marcken entitled: “Factored Representation Of A Set Of Priceable Units” filed as application Ser. No. 09/109,876, on Jul. 2, 1998, which patent is assigned to the assignee of the present application, ITA Software, Inc. (Cambridge, Mass.), as mentioned above and is incorporated herein by reference in its entirety.

The techniques disclosed in that patent price many itineraries simultaneously. The travel planning system disclosed in that patent searches by constructing and evaluating individual travel units such as fare-components and priceable-units, builds a representation of all the possible ways they can be combined to cover a journey, and enumerates specific answers from the representation (called the pricing graph).

Described below is a process 150 to extend the architecture described in the above patent (U.S. Pat. No. 6,381,578) to efficiently search for multiple ticket, PNR, or point-of-sale solutions simultaneously with the singleton, i.e. conventionally produced possibility.

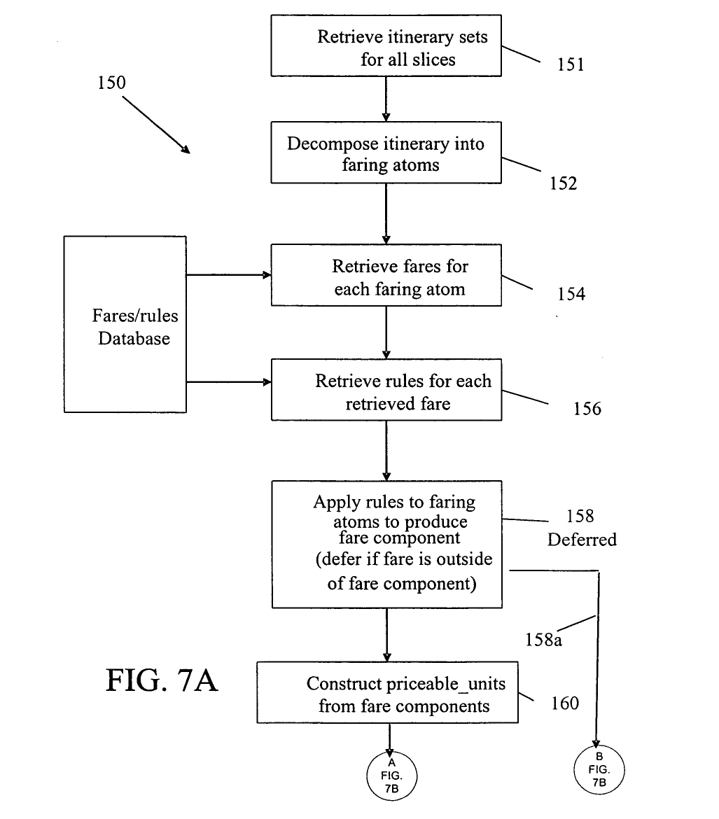

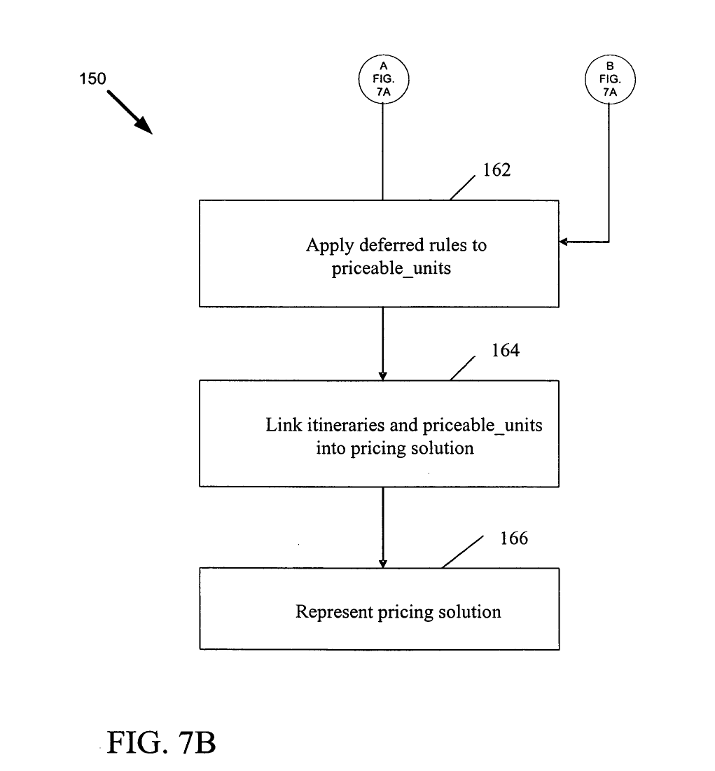

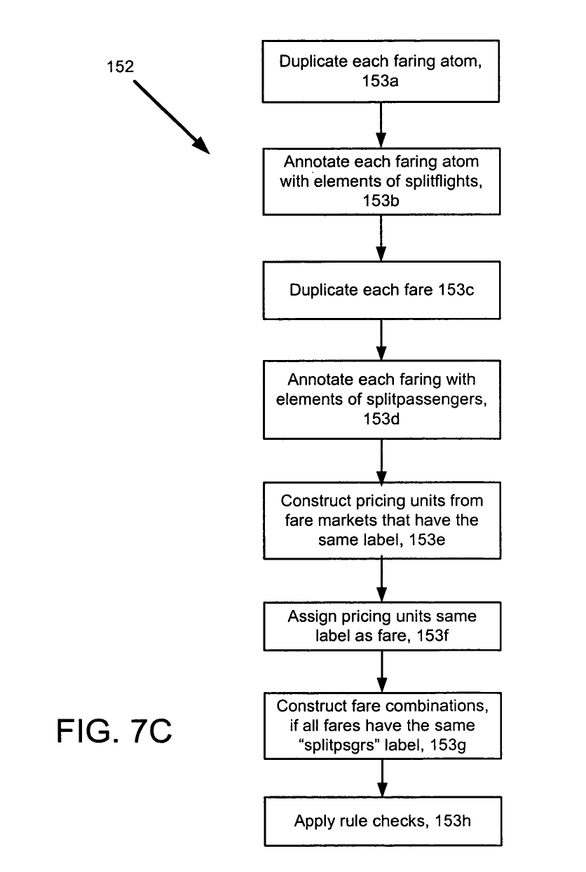

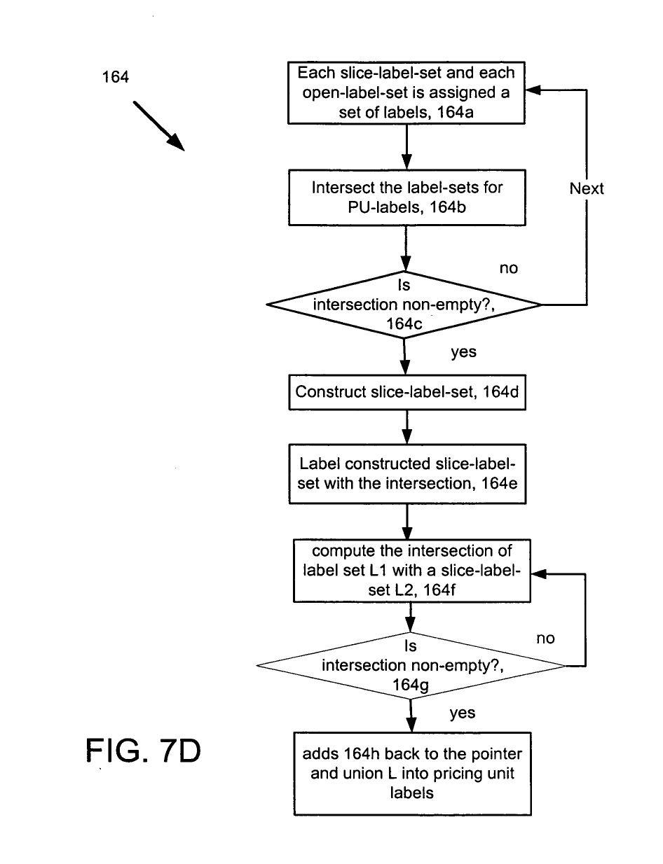

Referring to FIGS. 7A and 7B, a modification 150 of the faring process 18 (described in the above patent) is shown. The modified faring process 150 retrieves 151 itinerary sets for all slices in a journey. The itinerary sets are provided from a scheduler process (such as the one referred to in the patent or other scheduler processes) for each slice of a journey where a slice corresponds to a direction of travel. Thus, for example, for a round trip journey there would be two slices, one for the outbound part of the journey and one for the return part of the journey.

The faring process 18 decomposes 152 the complete itinerary into faring atoms. As used herein, faring atoms refer to a sequence of flight segments or equivalently legs that are spanned by a single fare. For example, the complete itinerary
UA005 from DFW to BOS at 12:30 on 12NOV
UA010 from BOS to YYZ at 18:00 on 12NOV
AC121 from YYZ to YVR at 01:00 on 13NOV

permits the following faring-atoms, as shown in TABLE 1, which is reproduced below:

TABLE 1

| Faring-Atom Number | Legs and Departure Times |
|---|---|
| 1 | DFW6BOS UA005 12NOV 12:30 |
| 2 | BOS6YYZ UA010 12NOV 18:00 |
| 3 | DFW6BOS UA005 12NOV 12:30 |
| | BOS6YYZ UA010 12NOV 18:00 |
| 4 | YYZ6YVR AC121 13NOV 01:00 |

A faring atom is represented by a data structure that preferably includes the following fields as shown in TABLE 2:

TABLE 2

| Faring-Atom fields | Use |
|---|---|
| legs-and-departure-times | A list of legs and their departure times |
| | and dates. |
| faring-market | The faring-market that this faring-atom is in. |
| cached-results | A storage space used to eliminate redundant |
| | computation in the rule-checking process. As |
| | rule record-2s are applied to faring-atoms, the |
| | results are stored in this field. If the |
| | same record-2 is applied again, the answer |
| | is retrieved rather than recomputed. |
| priceable-unit-labels | A list of the priceable-unit-labels that the |
| | faring-atom enters into. |
| Split Assumptions | List of assumptions required for the unit |
| | to be valid |

A field “Split Assumptions” is added to a faring atom representation. Split Assumptions the set of elements from Splits for which the faring-atom is valid, that it is a subset of Splits.

In addition as described below, fare-components and priceable-unit-labels are also modified to include such a Split Assumptions fields.

The faring process 150 decomposes 152 individual units of representation, e.g., faring atoms for the split possibilities by computing the units multiple times, with each time using different journey split assumptions, providing multiple faring atoms. The assumptions required for the unit of representation, e.g., faring atom to be valid are stored with the corresponding individual unit, e.g., the faring atom. An example of the process 152 to compute these multiple faring atoms is discussed in FIG. 7C, below.

After the faring process 18 decomposes 152 the itineraries into faring atoms, the faring process 18 retrieves 154 fares and rules 156 for each faring atom by accessing a fares/rules database, as is commonly known and disclosed in the patent. At this point a fare's routing is retrieved from a routing database and applied to the faring atom. If the routing test fails, the fare cannot be applied to the faring atom and a fare component is not built.

The faring process 18 applies the rules 158 to the faring atoms to produce fare components. Fare-components are combinations of faring-atoms and fares. Fare-components (TABLE 3) are produced if a fare's rules pass a preliminary check on a faring-atom. The fare-components are used to store deferred rules (e.g., deferred record-2s and combinability record-2s) that are applied at a later stage of processing. Fare components also store extra information produced during the rule-checking process, such as information about surcharges and penalties and discounts that are applied to the base fare price.

Table 3 which depicts an exemplary view of fare components is reproduced below:

TABLE 3

| Fare-Component fields | Use |
|---|---|
| Fare | The fare-component's fare. |
| faring-atom | The fare-component's faring-atom. |
| deferred-record-2s | A list of non-category-10 record-2s that have |
| | not been fully evaluated. |
| combinability-record-2 | If the fare's rules include a category-10 |
| | (a Fare Combinability record-2 is stored here). |
| Surcharges | A list of surcharges, penalties, discounts |
| | and other pieces of information produced during |
| | the rule-checking process. |
| Split Assumptions | List of assumptions required for the unit to be |
| | valid |

From the fare components, the faring process 18 constructs 160 priceable units. For certain types of rules such as those that require access to fares and/or flights from outside of the fare component, those rules are stored in the fare component for later or deferred evaluation. Construction 160 of priceable units takes valid fare components and constructs priceable units from the fare components. This process 160 involves grouping fare components from different slices and checking fare component combination restrictions. At this stage of processing, the rules deferred in step 158 are reapplied.

Priceable units are represented by priceable-unit-cores and priceable-unit-labels. Priceable-unit-cores are collections of fares and other information associated with fares within a priceable-unit, such as discounts and penalties and surcharges. Priceable-unit-cores (TABLE 4) are referenced by priceable-unit-labels.

Table 4, which shows exemplary priceable-unit-cores is reproduced below:

TABLE 4

| Priceable-Unit-Core fields | Use |
|---|---|
| Fares | A list of fares. |
| slice-numbers | A list of the slices the fares originate from. |
| Surcharges | A list of surcharges, penalties, discounts and |
| | other pieces of information produced during |
| | the rule-checking process. |
| Split Assumptions | List of assumptions required for the unit to |
| | be valid |

Priceable-unit-labels group a set of priceable-unit-cores with sets of faring-atoms. Together, the priceable-unit-cores and priceable-unit-labels are used to represent sets of priceable-units (TABLE 5).

Table 5, which shows exemplary sets of priceable-units is reproduced below:

TABLE 5

| Priceable-Unit-Label fields | Use |
|---|---|
| priceable-unit-cores | A set of priceable-unit cores. |
| slice-numbers | A list of the slices the fares and faring-atoms |
| | originate from. |
| faring-atom-sets | A list of sets of faring-atoms, one per slice. |

When all the fare components within a priceable unit are known, rules that were deferred from the processing 158 are applied 162 to the priceable unit sets of faring atoms.

After evaluation of the deferred record-2s at the priceable unit stage, the itineraries and priceable units are grouped together into complete sets of pricing solutions. This occurs by a linking process 164 that links itineraries to corresponding pricing units from different slices to provide the pricing solution 166. At this juncture, any remaining cross priceable unit fare combinability checks are performed to eliminate invalid combinations. The linking process 164 differs from that described in the patent to take into consideration, searching for multiple ticket, PNR, or point of sale solutions in a manner that is integrated with the faring process. Details on the linking process 164 are discussed in FIG. 7D.

Methods for Dividing a Journey and Passengers

Assume that the following different methods for dividing a journey and passengers into multiple PNRs/tickets are considered simultaneously in the process 150:

1. placing passengers on different PNRs;

2. dividing the journey by slice;

3. dividing the journey by priceable unit,

and simultaneously, multiple points of sale are also considered for each ticket.

For a given query, each of these methods translates into sets of specific split possibilities. For example, for three (3) passengers, possible splits include:

1. all passengers on the same PNRs

2. passengers 1 and 2 on same, 3 on different

3. passengers 1 and 3 on same, 2 on different

4. passengers 2 and 3 on same, 1 on different

5. all passengers on different

For a three-slice trip, possibilities for dividing the journey by slice are:

1. all slices on the same ticket

2. slices 1 and 2 on same ticket, 3 on different ticket

3. slices 1 and 3 on the same ticket, slice 2 on a different ticket

4. slices 2 and 3 on the same ticket, 1 on a different ticket

5. all slices on different tickets

Possibilities for dividing the journey by priceable units cannot be determined from the query alone. But, for each priceable unit considered, it is possible to consider both the possibility that the priceable unit appears alone and the possibility that all priceable units appear together on a ticket.

Not all of these split possibilities are compatible with one another. In particular, the method of dividing the journey by slice and by priceable unit are ordinarily incompatible. Generally, the splitting process will split the journey either by slice or by priceable unit, but not both (at least for priceable units that span slices). Furthermore, not all split possibilities need to be processed. For example, it may be more efficient only to consider a subset of the possibilities, such as all passengers separately or all passengers together, but not other possibilities (e.g., some passengers together and others separately).

Furthermore, it may be desirable to filter the set of split possibilities based on either known booking limitations or traveler preferences. For example, the possibility of breaking a solution within a slice may be conditioned on the length of layover to allow extra time for baggage transfer.

For convenience, call the set of different multi-ticket slice split possibilities “SplitSlices,” the set of different multi-ticket ways to divide PUs across tickets “SplitPUs,” and the set of passenger split possibilities “SplitPsgrs. The set “WholeItin” is the singleton set of not splitting the journey by either slice or PU. Roughly, the total set of ways to split the flights of answers into tickets is:

SplitFlights=SplitSlices union SplitPUs union WholeItin

and the total ways to divide a solution into tickets and PNRs is:

Splits=SplitFlights cross SplitPsgrs

Each of the elements of Splits has different implications for the evaluation of various rules and constraints, though most individual rules and constraints depend either on the choice of “SplitFlights” or “SplitPsgrs” but not both.

Referring to FIG. 7C, one way to decompose 152 (FIG. 7A) faring atoms to construct multiple units of representation, e.g., faring atoms for different split possibilities is shown. In this process 152, each faring-atom and faring-market is duplicated 153a and labeled 153b with the elements of “SplitFlights.” Each fare, during seat availability processing, is duplicated 153c and labeled 153d with the elements of “SplitPsgrs.” Priceable units are constructed 153e from faring-markets that have the same label, and are assigned 153f that label. The Fare combinations within a priceable unit are only constructed if 153g all of the fares have the same “SplitPsgrs” label. The PU-labels are distinguished by both the “SplitPsgrs” and “SplitFlights” labels of the faring-atoms and fares within (every PU-label has a single label from Splits).

Rule checks 153h are performed on units of representation, and the rule checks are altered to take into account the split label. Examples of rule checks that may be altered include:
1. Rule checks that depend on the journey departure time or location, when applied to faring-atoms, faring-markets or priceable units with a “SplitSlices” label, use the time or location of the first slice in the journey that is part of the split label.
2. Rule checks that depend on the journey departure time or location, when applied to faring-atoms, faring-markets with a “SplitPUs” label, check against the set of all consistent times and locations, which may necessitate deferring these checks until the PU-level of rule checks.
3. Rule checks that depend on the times or locations within the priceable unit, when applied to faring-atoms, faring-markets with a SplitPUs label, use whole-journey time bounds, which may cause rule deferral to the priceable unit level of application. Rule checks with a SplitPUs label when applied at the priceable unit level assume the priceable unit is the whole journey.
4. End-on-end fare combinability restrictions are only applied to fare-components with the same labels.
5. Booking code checks applied to fares with labeled with elements from SplitPsgrs alter the set of available booking codes as appropriate: booking code decrementing is used to reduce counts by the sum of the number of higher priority passengers not in the set.

In some cases it may be more efficient to label fares, faring-atoms, faring-markets, and priceable-units with a set of consistent labels, thus sharing work. For example, rather than pre-multiplying the number of fares by the number of “SplitPsgrs” labels, during booking code availability checks, a loop is made over “SplitPsgrs” labels and checks are performed, as appropriate. If the checks pass, the label is added to the set of labels for the fare.

As another example, for any particular unit of representation, several split labels may be equivalent, because the split labels reflect different behavior only on other parts of the journey. The elements of “SplitSlices” for a faring-atom or faring-market in slice 1, there is no need to distinguish between the split case where all slices are on different tickets from that where slice 1 is on one ticket and slices 2 and 3 are on another. Thus, it is more efficient to label faring-atoms and faring-markets using a set. Checks to determine whether two faring-markets can be combined into a priceable-unit are performed by checking whether the intersection of labels is non-empty, and the priceable unit (e.g., priceable unit label) is labeled with the intersection.

The linking process 164 (FIG. 7B) is modified from that of the linking process described in U.S. Pat. No. 6,381,578, mentioned above, to construct the pricing graph from fare components and itineraries enforcing an integrity or consistency of the journey split assumptions that are required for the units to be valid.

The linking process 164 (detailed in FIG. 7D) involves slice-label-sets and open-label-sets data structures. Slice-label-sets data structures group itinerary divisions by the multi-slice priceable-unit-labels they can enter into. In each slice of a journey, a unique slice-label-set is constructed for every set of multi-slice priceable-unit-labels. Each slice-label-set stores both the set of multi-slice priceable-unit-labels and a set of itinerary-label-holders, which contain single-slice priceable-unit-labels on a per-itinerary basis. Each slice-label-set is a pair of an itinerary and a set of division-label-holders. Each of these division-label-holders is a pair of a division and a set of sets of single-slice priceable-unit-labels (TABLE 6).

Table 6 which depicts exemplary single-slice priceable-unit-labels is reproduced below:

TABLE 6

| | Use |
|---|---|
| Slice-Label-Set fields | |
| multi-slice-PU-labels | A set of multi-slice PU-labels. |
| itinerary-label-holders | A set of itinerary-label-holders. |
| Itinerary-Label-Holder fields | |
| Itinerary | An itinerary. |
| division-label-holders | A set of division-label-holders. |
| Division-Label-Holder | |
| fields | |
| Division | An itinerary division. |
| single-slice-PU-label-sets | A set of sets of single-slice PU- |
| | labels. |

Open-label-sets data structures (TABLE 7) are used to summarize the state of the linking process 164. Each is a set of “open” multi-slice priceable-unit-labels and a set of backward-links. Each of these backward-links is a pair of a “slice-label-set” and an “open-label-set.”

Table 7, which depicts exemplary Open-label-sets data structures is reproduced below:

TABLE 7

| | Use |
|---|---|
| Open-Label-Set fields | |
| open-PU-labels | A set of open multi-slica PU-labels. |
| backward-links | A set or backward-links. |
| Backward-Link fields | |
| slice-label-set | A slice-label-set. |
| open-label-set | An open-label-set. |

These changes result in a pricing-graph that enforces multiple-ticket consistency and that, in one pricing graph, simultaneously represents a multitude of partitioning possibilities, including the ordinary possibility of a single PNR.

Referring to FIG. 7D, an example of the linking process 164 that links itineraries to corresponding pricing units in a manner that enforces split consistency is shown. Each slice-label-set and each open-label-set is assigned 164a a set of labels. For the slice-label-sets, after providing a set of PU-labels, the label-sets for those PU-labels are intersected 164b. If the intersection of the label sets for those PU-label is non-empty 164c, a slice-label-set is constructed 164d and labeled 164e with the intersection.

For the open-label-set s, to combine a previous open-label-set with label set L1 with a slice-label-set with label set L2 to produce a new open-label-set, the linking process computes 164f the intersection L of L1 and L2. If the intersection is non-empty 164g, and produces an open-label-set that does not already exist, the process 164 adds 164h back the pointer and union L into pricing unit labels.

Enumeration of solutions can be unchanged, although it may be desirable to analyze the labels on solution components and annotate the solution with the split requirements (that is, how the solution must be partitioned for reservation and ticketing purposes).

In the (U.S. Pat. No. 6,381,578) patent, the linking algorithm links itineraries to corresponding pricing units from different slices to provide pricing solutions. The pricing solutions in that patent are represented in a compact manner, such as in a directed acyclic graph (DAG) structure, referred to therein as a pricing graph.

Solution Enumeration

Selling a solution as multiple tickets, or reserving it as multiple PNRs, has consequences for both a travel agent and a traveler. The primary advantage is usually either a cheaper total price, or working around restrictions that could have outright prevented a sale. Disadvantages include extra hassle for the agent, possibility of confusion for the airline and traveler during the trip, and so forth.

It may be advantageous to explicitly adjust a preference for a solution based on its ticketing properties. For example, in the patent mentioned above, a value function is used to rate solutions and penalties can be added into the pricing-graph, by adding a special penalty object to the first-slice-label-sets based on its labels. This gives value functions access to the solution partition, permitting the assessment of penalties to multiple-ticket or multiple-PNR solutions, and the possibility of variable penalty levels (for example, higher penalties to splits that occur within-slice). It also enables multiple-ticket solutions to be turned on and off in user interfaces.

It may furthermore be beneficial to include solution partitions with diversity conditions. For example, it may be desired to enumerate solutions by price but also to always enumerate some solutions that do not involve multiple tickets. Thus, it may be advantageous to include split type in the set of diversity conditions. (See, for example, U.S. patent application Ser. No. 09/431,365 filed Nov. 1, 1999 entitled “Method for Generating A Diverse Set of Travel Options” by Carl G. de Marcken incorporated herein by reference and assigned to the assignee of the present invention.

It will frequently be the case that partitioning a solution into multiple tickets or PNRs is possible but conveys no particular advantage. In such a case it may be undesirable to present multiple pricings for the same flights that vary only by partition. It is therefore expected that in ordinary usage multiple solutions that are similar in important respects (in particular, involve the same flights) will be collected and culled into the single most desirable solution (typically, that ranked highest by a value function, perhaps taking into account split penalties).

Traffic Restrictions

Airlines frequently assign so-called “traffic restrictions” to flights. These restrictions prevent the use of certain flights unless in combination with another. A typical use is to prevent the use of a code share flights marketed by airline A and operated by airline B, unless a connection is made to another flight actually operated by A. Because of traffic restrictions, a sequence of flights that could be sold as a single ticket may not always be able to be partitioned for sale.

In a travel planning system that prices whole-trip itinerary, it may be advantageous to not consider partitioning the itinerary into a particular set of flights if one of the sets fails to satisfy traffic restrictions.

In a travel planning system such as that of the (U.S. Pat. No. 6,381,578) patent that prices multiple combinations of sub-itineraries simultaneously, it may be advantageous to mark sub-itineraries that cannot be sold on their own because of Traffic Restriction (TR) violations, and during the linking process, avoid generating slice-label-sets for those itineraries that combine the itinerary with PU-labels assigned split labels that isolate the sub-itinerary.

Explaining Split Reasons

A traveler or travel-agent may wish to understand why a solution is reserved or purchased in multiple pieces. The reasons can be computed in a variety of ways and displayed in a user interface.

1. The solution can be re-priced as a single entity forcing the same fares, priceable units, and booking codes, and failures recorded.

2. Explicit checks can be made of various likely causes, such as checking whether different passengers use different booking codes for the same flights, checking whether multiple airlines appear in the solution that do not have ticketing agreements, checking each fare's end-on-end combinability restriction against other fares, etc.

Multiple Points of Sale

Airlines commonly condition prices on “point of sale,” a term that encompasses the identity of the selling travel agency and global distribution system (GDS), and sometimes also based on factors more closely tied to the passenger, such as the identity of the organization that employs the selling travel agency. For example, an airline may make a discount fare available for sale only by a particular travel agency when booking through a particular GDS, or only to employees of a particular company. They also condition seat availability on such information, i.e., the query from a travel planning system to an airline about seat availability for a flight typically includes travel agency and passenger information, and the airline may change its answer depending on these values (offering a Q booking code to a preferred agency or frequent flyer, but not to others).

Typically, travel planning systems accept only a single travel agency and traveler identifier for a query. However some travelers and some agencies may have flexibility over how they identify themselves. For example, a traveler has a choice over what agency they buy a ticket through, and an agency may have choices over what GDS sales are made through.

In the context of dividing a solution into multiple PNRs or tickets, the possibility exists that each will be sold through different agencies or global distribution systems (GDS's), or using different traveler identification information (e.g., different frequent flyer numbers).

Thus, it is desirable that a travel planning system accept in a query a set of possible points of sale and include in its search space the choice of which to select. If the entire solution is sold as one unit it may be required that the fares and booking codes be consistent with a single point of sale from the set; if the solution is sold as several units each may use a different POS.

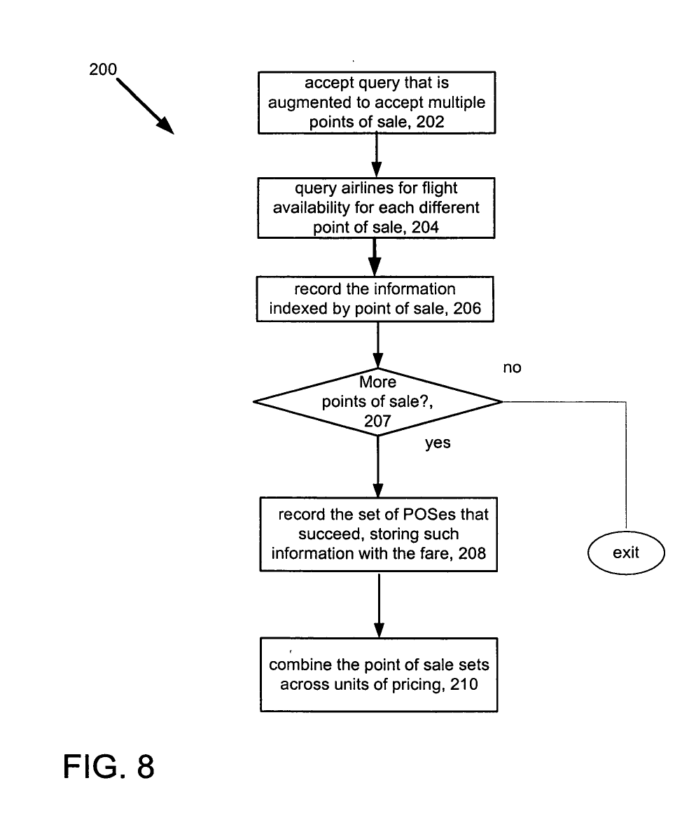

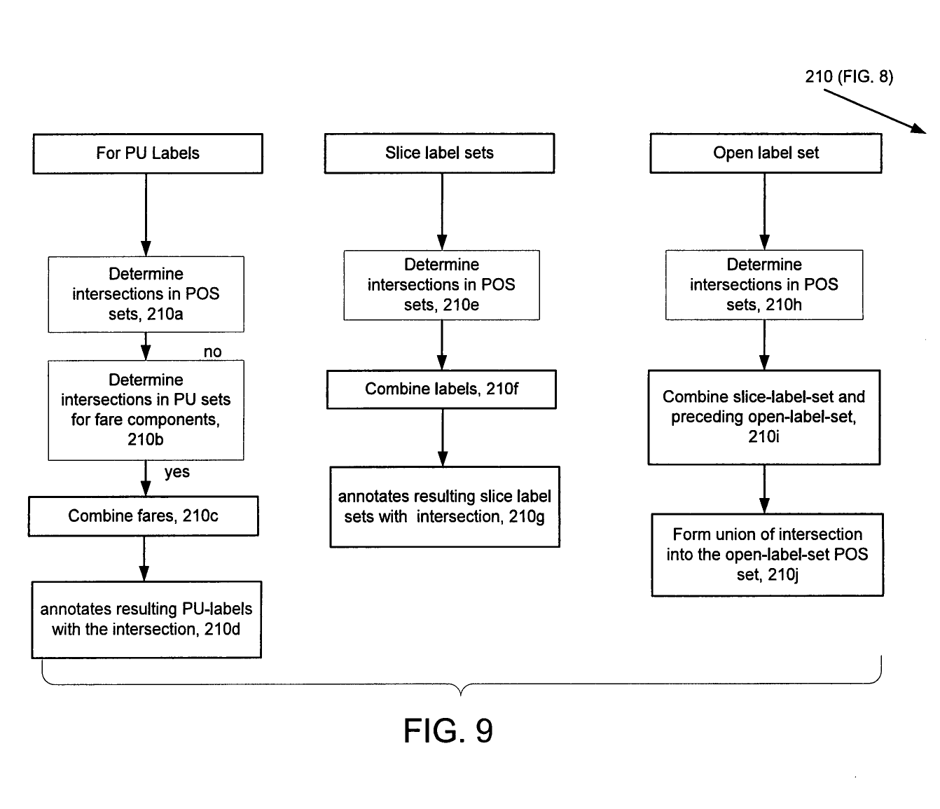

Referring to FIG. 8, a process 200 to process a set of possible points of sale during a search of pricing solutions and to provide a choice of which points of sale to select can be implemented independently of or with multiple-PNR/ticket processing discussed above.

The process 200 accepts 202 a query that is augmented to accept multiple points of sale. The process 200 will query 204 airlines for flight availability for each different point of sale, and record 206 the information indexed by point of sale. The process will iterate 208 over all points of sale and record the set of POSes that succeed, storing such information with the fare. This iteration can be performed during fare rule checks and booking code availability checks that depend on points of sale. In the context of the travel planning system described in the patent (U.S. Pat. No. 6,381,578), this would be stored in the fare-components. The process 200 combines 210 the point of sale sets as appropriate across units of pricing, in a manner analogous to the way split labels are propagated in the previously described algorithms; for example, in the context of the travel planning system described in the patent.

Referring to FIG. 9, the process 210 (FIG. 8) to combine the points of sale sets combines the point of sale sets according to the stage of processing. Thus, while constructing the PU's the process 210 determines 210a intersections of POS sets and determines 210b if there is an intersection in the POS sets for the PU's fare-components. The process combines 210c fares only if there is an intersection in the POS sets, and annotates 210d the resulting PU-labels with the intersection.

While constructing slice-label-sets, the process 210, determines 210e if there is an intersection of the POS sets and combines 210f PU-labels only if there is an intersection of the POS sets, and annotates 210g the resulting slice-label-sets with the intersection.

While constructing open-label-set s, the process 210 determines 210h if there is an intersection of the POS sets and combines 210i the slice-label-set and preceding open-label-set (if any) if there is an intersection of the POS sets and forms 210j a union of this intersection into the open-label-set POS set.

To combine with multiple-ticket processing it is further necessary to ensure that each ticket is priceable using a single POS. This requires maintaining during the linking process 164 the set of point of sale POS for each ticket. The changes are expressed using a form of the search algorithm where each PU-label, open-label-set and slice-label-set is assigned a single split label rather than a set.

Other embodiments are within the scope of the claims. For example, fare-components and PU-labels are distinguished by both a point of sale (POS) set and split label. Each slice-label-set and open-label-set, rather than having a POS set, can have a table mapping a split-identifier to the POS set, where a split identifier is an object representing a component of a split partition.

For example, the following pseudo code could be used:

```
    for each PU-label with split label 1, assign the PU-label a
    split-identifier
i:
  if 1 is in SplitSlices, i is the set of slices that is the partition component
of 1 that contains the PU;
      if 1 is WholeItin, i is a canonical object, call it ‘nil’;
        if 1 is in SplitPUs, i is the partition component of 1 that
contains the PU, for the case where each PU is to be sold separately,
i is simply the PU-label itself.
    when construcing slice-label-sets, for every split-identifier i across all
the PU-labels, intersect the POS sets for all PU-labels with split-identifier i
to produce POS_i ; if all POS_i non-empty, assign slice-label-set the
table { i -> POS_i } and distinguish slice-label-sets by this table
    for efficiency, can drop table elements where i is a PU-label or i is a
single slice, since in that case the POS information does not need to be
propagated)
    when combining a previous open-label-set with POS table T1 with a
slice-label-set POS table T2 to produce a new open-label-set, let I be set of
split-identifiers that appear in both T1 and T2, and J1 be set that appear
only in T1, and J2 be set that appear only in T2;
    for every i in I compute T[i] = T1[i] intersect T2[i]; if all non-empty,
construct new table mapping { i -> T[i] }
```

While examples from air travel planning have been described, aspects apply equally well to many other forms of travel planning, such as car, bus or train travel planning, or mixed car and bus and train and air travel planning. Accordingly, other embodiments are within the scope of the following claims.

What is claimed is:

1. A method for producing a travel solution comprised of multiple travel units, the method comprising:
sending a travel planning query to a travel planning system, the travel query including a specification of whether or not to expand a search space to include multiple passenger name records, or tickets or sales channels; and
processing the travel query to return solutions with a specification of possible partitions of the solutions into at least one of passenger name records (PNRs), tickets or sales channels for the returned solutions.

2. The method of claim 1 wherein the query specifies the types of partitions that are allowed.

3. The method of claim 1 wherein the type of partition of complete solutions is to sell multiple passengers individually.

4. The method of claim 1 wherein the type of partition of complete solutions is to sell each priceable unit separately.

5. The method of claim 1 wherein the type of partition of complete solutions is to sell each airline separately.

6. The method of claim 1 wherein the type of partition of complete solutions is to sell each slice or trip-segment separately.

7. The method of claim 1 wherein processing comprises:
processing the query by:
generating a plurality of possible itineraries comprised of flight sequences, for the entire journey; and thereafter,
pricing each itinerary to produce a set of solutions.

8. The method of claim 7 wherein generating a plurality of possible itineraries comprises:
enumerating sets of sub-itineraries for each slice;
producing a cross product of the enumerated sets of sub-itineraries to provide resulting possible itineraries; and
pruning the resulting possible itineraries to a manageable number of whole-trip itineraries, based upon criteria.

9. The method of claim 8 wherein pricing comprises:
pricing each sub-itinerary, for each slice, as a single ticket.

10. The method of claim 8 wherein pricing comprises:
pricing multiple-ticket options by combining per-trip-segment tickets.

11. The method of claim 8 wherein pricing comprises:
determining a set of cheapest multiple-ticket solutions by constructing the set from the cheapest tickets for each trip segment;
adding the cheapest multi-ticket solutions to the set of solutions.

12. A computer program product residing on a computer readable medium for producing a travel solution comprised of multiple travel units, the computer program product comprising instructions to cause a computer to:
send a travel planning query to a travel planning system, the travel query including a specification of whether or not to expand a search space to include multiple passenger name records, or tickets or sales channels; and
process the travel query to return solutions with a specification of possible partitions of the solutions into at least one of passenger name records (PNRs), tickets or sales channels for the returned solutions.

13. The computer program product of claim 12 wherein the computer program operates on the query, and with the query specifying the types of partitions that are allowed.

14. The computer program product of claim 13 wherein the computer program operates on the query that specifies the types of partitions, with one of the partition of complete solutions is to sell multiple passengers individually.

15. The computer program product of claim 13 wherein the computer program operates on the query that specifies the types of partitions, with one of the partition of complete solutions is to sell each priceable unit separately.

16. The computer program product of claim 13 wherein the computer program operates on the query that specifies the types of partitions, with one of the partition of complete solutions is to sell each airline separately.

17. The computer program product of claim 13 wherein the computer program operates on the query that specifies the types of partitions, with one of the partition of complete solutions is to sell each slice or trip-segment separately.

18. The computer program product of claim 12 wherein instructions to process further comprises instructions to processing the query by instructions to:
generate a plurality of possible itineraries comprised of flight sequences, for the entire journey; and thereafter,
price each itinerary to produce a set of solutions.

19. The computer program product of claim 18 wherein instructions to generate a plurality of possible itineraries comprises instructions to:
enumerate sets of sub-itineraries for each slice;
produce a cross product of the enumerated sets of sub-itineraries to provide resulting possible itineraries; and
prune the resulting possible itineraries to a manageable number of whole-trip itineraries, based upon criteria.

20. The computer program product of claim 19 wherein instructions to price comprises instructions to:
price each sub-itinerary, for each slice, as a single ticket.

21. The computer program product of claim 19 wherein instructions to price comprises instructions to:
price multiple-ticket options by instructions to combine per-trip-segment tickets.

22. The computer program product of claim 19 wherein instructions to price comprises instructions to:
determine a set of cheapest multiple-ticket solutions by constructing the set from the cheapest tickets for each trip segment;
add the cheapest multi-ticket solutions to the set of solutions.
